(19) United States
(12) Patent Application Publication
(10) Pub. No.: US 2019/0013194 A1
(43) Pub. Date: Jan. 10, 2019

(54) ION EXCITATION METHOD IN LINEAR ION TRAP

(71) Applicant: FUDAN UNIVERSITY, Shanghai (CN)

(72) Inventors: Qiankun DANG, Shanghai (CN); Xiaodong XIE, Shanghai (CN); Fuxing XU, Shanghai (CN); Yinjuan CHEN, Shanghai (CN); Chuanfan DING, Shanghai (CN)

(21) Appl. No.: 15/556,109

(22) PCT Filed: Nov. 23, 2015
(86) PCT No.: PCT/CN2015/095259

§ 371 Date: Sep. 18, 2018

(30) Foreign Application Priority Data
Mar. 6, 2015 (CN) 201510099378.6

(51) Int. Cl. H01J 49/42; H01J 49/16; H01J 49/06

(52) U.S. Cl. CPC H01J 49/4225; H01J 49/423; H01J 49/063; H01J 49/165

(57) ABSTRACT

The present invention relates to the technical field of mass analysis instruments. Disclosed is an ion excitation method in a linear ion trap. The method comprises: in a linear ion trap, and at an ion collision-induced dissociation stage, simultaneously applying an auxiliary excitation signal in radial X and Y directions thereof; increasing the kinetic energy of ions in the two directions, thereby increasing collisions with a center gas to cause dissociation; and converting the kinetic energy to internal energy to achieve tandem mass spectrometry analysis. The kinetic energy in the X and Y directions of the ion is increased, and compared to a conventional dissociation method in which ions are primarily excited in one direction, more kinetic energy is converted to internal energy, thus improving dissociation efficiency, shortening reaction time, and addressing a low mass cutoff effect in the ion trap.

### FIELD OF THE INVENTION

The present invention relates generally to ion trap mass analyzers and more particularly to methods for carrying out ion excitation.

### BACKGROUND OF THE PRESENT INVENTION

Mass spectrometry (MS) has been widely used in a range of fields such as chemistry, biology, food safety, industrial pharmaceutical manufacturing, environmental monitoring and homeland security because of its excellent ability to identify and quantify chemical compounds. Tandem mass spectrometry (MS/MS) is the key technology for primary structural characterization of molecules in mass spectrometry. There are several examples of MS/MS techniques that are used in ion trap instruments, such as collision-induced dissociation (CID), electron transfer dissociation (ETD), infrared multiphoton dissociation (IRMPD), proton transfer disassociation and electron capture dissociation (ECD). Among these, CID has been widely used owing to its easy implementation and high predictability.

Linear ion trap (LIT) is an important device in mass spectrometry. LITs have been widely used as standalone mass spectrometers or ion storage devices, and they can also be combined with other mass analyzers such as time-of-flight, quadrupole, etc. to form more complex and versatile analytical systems. In these systems, LITs can be used to select ions of a certain mass-to-charge ratio, study ion-molecular reactions, and enhance other aspects of mass spectrometry performance. As mass analyzers, they have some significant advantages, such as relatively simple structure, small volume, high working pressure and capability of performing tandem mass spectrometry in a single chamber.

First, the parent ion is isolated and ions of interest are selected by Fourier transform waveform or a forward or reverse scan or a stable map vertex isolation. Then, CID in a QIT is implemented by applying an alternating current (AC) potential that matches the ion duration frequency to increase the amplitude of ion vibration close to the edge of the electrode. The mass-selected ions (precursor ions) move close to the electrodes and thereby increase energy. Collisions of the ion with the buffer gas will convert the energy into ion internal energy continually to achieve dissociation.

In the CID process, internal energy must be sufficient to break chemical bonds and produce efficient ion fragmentation. The qᵤ value determines the maximum amount of energy which can be imparted to the ion upon excitation. It is defined by the following equation:

$${q}_{\text{?}} = \frac{4 e V}{{mr}_{0}^{2} {Ω}^{2}}$$

$$\text{?} \text{indicates text missing or illegible when filed}$$

where q is a relationship proportional to the amplitude of the RF voltage, m is the ion mass, e is the ion charge, Ω is the main radio frequency (RF) power angular frequency, V is the main RF power amplitude, r₀ is the field radius.

The movement of ions in the trap can be thought of as moving in a potential trap whose function cannot exceed the depth of the potential trap. Since the movement of ions in the x and y directions does not affect each other in the ideal quadrupole field, it is only necessary that the function in each direction does not exceed the depth of the trap. For q<0.4, the approximate expression of the trap depth is:

$${D}_{x} = {D}_{y} = \frac{qV}{4}$$

To achieve collision-induced dissociation, the value of q must be suitable. At a low q value, the precursor ions are easily ejected because of a shallow potential trap depth. Additionally, energy deposited into the precursor ions is not enough to form product ions. However, if a large q value is chosen, more fragment ions will be lost as a result of the low mass cut-off (LMCO) effect, which is referred to the fact that those ions below the mass-to-ratio trapped at q=0.908 cannot be trapped. As a compromise, CID is usually performed between q value of 0.2 and 0.4 to obtain sufficient dissociation the smaller the q value the better.

There are mainly two methods for redeeming LMCO effects. The first is to decrease q value by increasing the initial internal energy or improving the conversion efficiency of ion kinetic energy to the ion internal energy, for example, thermally assisted collision-induced dissociation (TA-CID)(Ref 1). Secondly, ions are activated at a high q value for a very short time followed by a period with a low q value so that ion disassociation happens at a low q value, such as pulsed q dissociation (PQD) (Ref 2)

Presently, the conventional collision-induced dissociation method in linear ion traps only applies an auxiliary excitation signal on a pair of electrodes of the trap, because the two directions in the ideal quadrupole field do not affect each other, mainly causing the ions to be excited in the x or y direction. If the ions can be excited simultaneously in both directions, the average kinetic energy and maximum function of the ions are improved, compared to the one-way excitation, so that the q value can be lowered.
Reference 1: Racine A. H., Payne A. H., Remes P. M., Glish G. L. Thermally assisted collision-induced dissociation in a quadrupole ion trap mass spectrometer. Anal. Chem. 78, 4609-4614(2006)
Reference 2: Schwartz, J. C., Syka, J. E. P., Quarmby, S. T. Proceedings of the 53rd ASMS Conference on Mass Spectrometry and Allied Topics; San Antonio, Tex., Jun. 5-9 (2005)

### SUMMARY OF THE INVENTION

The invention provides a method for ion excitation for collision-induced dissociation in linear ion trap that is capable of increasing the average kinetic energy and maximum function of ions. In the present invention, ions are excited simultaneously in two radial coordinate directions (X and Y), thereby increasing the average kinetic energy and maximum function of ions. In a specific implementation, an auxiliary AC voltage is applied in a dipole manner on the pair of electrodes x and y, that is, the phase of the alternating signal applied on the opposite pair of electrodes is 180 degrees out of phase: or, in x and y auxiliary alternating voltage, is applied to the electrodes in a unipolar manner, i.e., an alternating current signal is applied only to a single electrode.

In linear ion traps, the traditional ion excitation method mainly causes the ions to increase in amplitude in a single coordinate direction. In a pure quadrupole field, the ion amplitude has the following relationship with the average kinetic energy:

$${E}_{r} = \frac{m Ω}{8} {r}_{i}^{2} {v}_{21}^{2} ( 0 , q ) + \frac{m}{2 {γ}_{⊥}^{2}} {v}_{22}^{2} ( 0 , q )$$

where m is the ion mass, Ω is the main radio frequency (RF) power circular frequency, rᵢ is the maximum particle motion radius,

$$\frac{1}{{v}_{⊥}}$$

is me most probable ion thermal speed, and v₂₁²(0,qᵤ) and v₂₂²(0,qᵤ) are the dimensionless parameters that depend only on the RF field properties. The first variable is the main determining factor to the ion kinetic energy, and it is proportional to rᵢ².

rᵢ²=xₜ²+yₜ²

Therefore, when ions are excited in both x- and y-directions, ions will move in the xy plane, rather than along x or y axis. Thus, the kinetic energy can be increased due to the larger ion moving radius and the addition of another excitation dimension.

The potential trap depth for ions moving in the xy plane is

$${D}_{xy} = D ( 1 + {tan}^{2} θ )$$

$$θ = \{ \begin{matrix}∅ 0 \leq ∅ \leq 45 ° \\ 90 ° - ∅ 45 ° \leq ∅ \leq 90 °\end{matrix}$$

where D is the trap depth in one dimension, Φ is the angle between the x-axis and the straight line between the origin and the ion position (less than 90 degrees). It can be seen that moving along a certain angle, the potential trap is deeper, and the functions that can be achieved are also greater.

In addition, the x and y directions move simultaneously, and the ions are in a higher function for a longer period of time. Since the unidirectional excitation kinetic energy changes approximately sinusoidally with time, in a period, even if the x-direction kinetic energy is at the lowest value, the y-direction kinetic energy can be at a high value in comparison, which increases the average kinetic energy.

In this method, two AC excitation signals are typically applied to the two pairs of LIT electrodes in dipolar fashion. They can also be applied in monopolar fashion, where each of the two AC signals is only applied to one electrode. The auxiliary AC waveforms can only have one frequency component, such as sinusoidal wave, rectangular wave or triangular wave. The auxiliary AC waveforms can also be the sum of multiple frequency components, such as noise signal, stored waveform inverse Fourier Transform (SWIFT) signal. The type of the two AC waveforms can be the same and for the same type the frequency, amplitude and phase difference can be the same or different. The type of the two AC excitation waveforms can be different, for example, the phase difference can vary from 0 to 360 degrees, but not 90 degrees. In the present invention, the two alternating current signals applied to the x and y electrodes may be completely different in type, such as a sine wave on the x electrode and a sine wave containing a plurality of frequencies on the y electrode.

The two AC signals are applied to the electrodes in the ion dissociation stage.

This method can be used in various types of linear quadrupole devices, such as linear quadrupoles, linear ion trap with the hyperbolic electrodes, rectilinear ion trap, and triangular-electrode linear ion trap, dual plane linear ion trap and other linear traps of various shapes and configurations.

In this method, ions are excited in both x- and y-directions, while ions are only excited in one direction in the conventional method. More energy can be deposited into the mass selected precursor ions, which arises from the following two factors: the addition of an excitation dimension and larger ion motion amplitude in either x- or y-direction. As a result, the ion dissociation rate constant and fragmentation efficiency are all increased, and the LMCO effect is redeemed.

### BRIEF DESCRIPTION OF THE FIGURES

FIG. 1 is using a quadrupole as a model of a linear ion trap, the present invention employs an auxiliary voltage signal application diagram implemented in a dipole manner.

FIG. 2 is a schematic illustration of an implementation circuit of a specific embodiment 1 of the present invention, wherein a triangular electrode ion trap is used as a linear ion trap.

FIG. 3a: embodiment 1, is a simulation of the ion motion trajectory of 10 mass-to-charge ratio 556 ions in a conventional one-way excitation within 20 ms.

FIG. 3b; embodiment 1, simulation of the ion motion trajectory of 10 mass-to-charge ratio 556 ions in the inventive two-way excitation within 20 ms.

FIG. 4a: embodiment 1, simulation of the ion x-direction motion trajectory for mass-to-charge ratio 556 ions in the traditional one-way excitation as a function of time

FIG. 4b: embodiment 1, simulation of the ion y-direction motion trajectory for mass-to-charge ratio 556 ions of the present invention under the two-way excitation as a function of time.

FIG. 5a: embodiment 1, simulation of ion radial kinetic energy Er for mass-to-charge ratio 556 ions in the traditional one-way excitation as a function of time.

FIG. 5b: embodiment 1, simulation of ion radial kinetic energy Er for mass-to-charge ratio 556 ions of the present invention under the two-way excitation over time

FIG. 6: a schematic diagram of the structure of the instrument platform of embodiment 1.

FIG. 7a: embodiment 1, the ratio of the fragment ion a4/b4 of the enkephalin sample to the q value in the conventional one-way excitation (represented by 1) and the two-way excitation of the present invention (represented by 2)

FIG. 7b: embodiment 1, the relationship between the fragmentation efficiency and the value of q for an enkephalin sample in both conventional one-way excitation and two-way excitation of the present invention

FIG. 8a: embodiment 1, a tandem mass spectrum under one-way excitation of the enkephalin sample of embodiment 1 with an excitation amplitude of 200 mV and an excitation time of 20 ms, obtaining the same energy deposition (fragment ion a4/b4=3).

FIG. 8b: embodiment 1, a tandem mass spectrum under two-way excitation of the enkephalin sample of embodiment 1 with an excitation amplitude of 200 mV and an excitation time of 20 ms, obtaining the same energy deposition (fragment ion a4/b4=3).

### DETAILED DESCRIPTION

The present invention will now be described in further detail with reference to the accompanying embodiments and drawings.

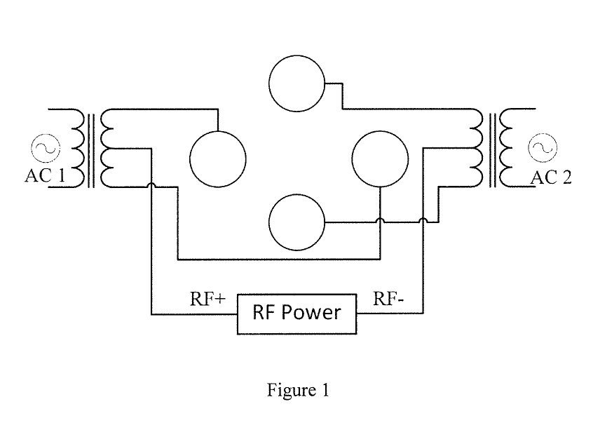

In the present invention, ions in the linear quadrupole devices are excited in the two-ways by applying auxiliary excitation signals in the x and y directions. Compared to the conventional single-way excitation method, the ion kinetic energy is increased and therefore more internal energy will be deposited into ions during collision-induced dissociation. FIG. 1 is an embodiment of the present invention wherein two auxiliary excitation signals are applied in dipolar fashion to the two pairs of electrodes in one embodiment of the invention. As the quadrupole is a model of a linear ion trap, the invention is applicable to all linear ion traps. Two RF signals with opposite phases are fused by a condensed line to an auxiliary AC signal and then were applied to a pair of opposing electrodes. The RF Signals are identical to the AC signal but 180 degrees out of phase. That is to say, AC signal is applied in dipolar fashion. AC signal can also be applied to only one electrode of each pair and this is in monopolar fashion. The auxiliary AC signal can be various types of waveforms which contain only one frequency component, such as sinusoidal wave, triangular wave, and square wave signals. It can also be waveforms which is the superimposition of several or a number of frequency components, such as noise signal, stored waveform inverse Fourier Transform (SWIFT) signal and so on. The two auxiliary excitation signals AC1 and AC2 can be the same type, for example both are sinusoidal wave. They can also be different types of AC signals, for example, AC1 is sine wave, and AC2 is square wave. If the two AC signals are the same type, the AC1 and AC2 can be exactly the same, including the amplitude, frequency, and phase. If it is a square wave signal of a single frequency, the duty ratios of the two signals may be the same or different.

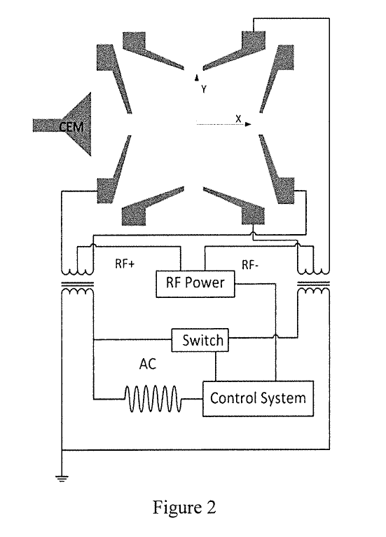

Embodiment 1, FIG. 2 which shows a schematic illustration of the electric circuit for the superposition of dipolar AC in a dipole manner in triangular-electrode linear ion trap. An auxiliary AC waveform produced by the control system is separated into two equal AC signals, as depicted in FIG. 2. One AC signal is coupled to one RF signal through a switch and then applied to the electrodes. The other AC signal was also coupled to the out-of-phase RF signal and then applied to the other electrodes. The signal switch can control whether the auxiliary AC signal is put out and not put out in different timing stages CID experiments involve several stages including ion injection, ion cooling, ion isolation, collision-induced dissociation, and mass analysis. For conventional CID, the switch is off at all time and there is no auxiliary AC signal output.

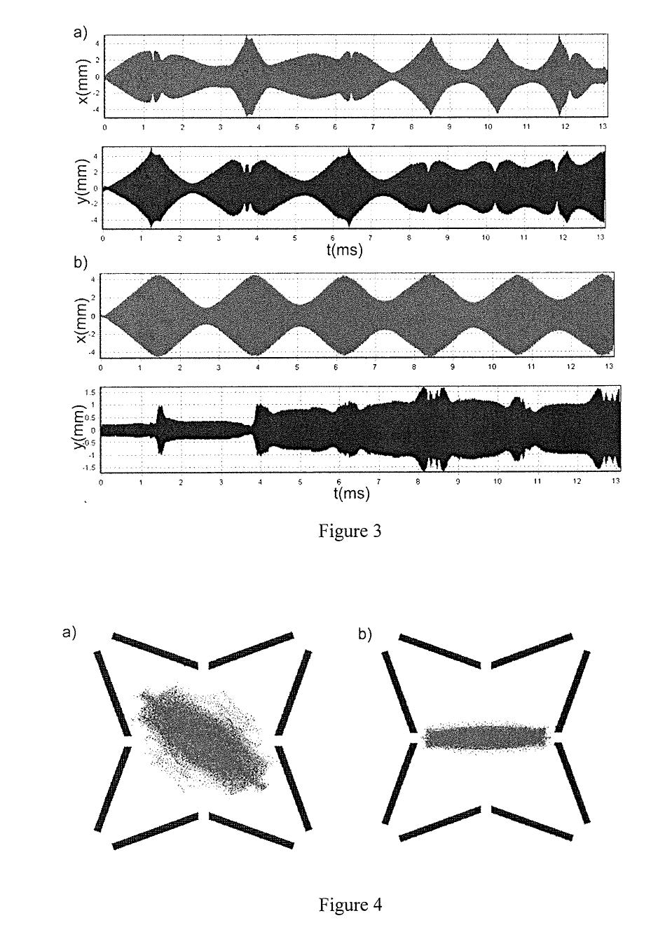

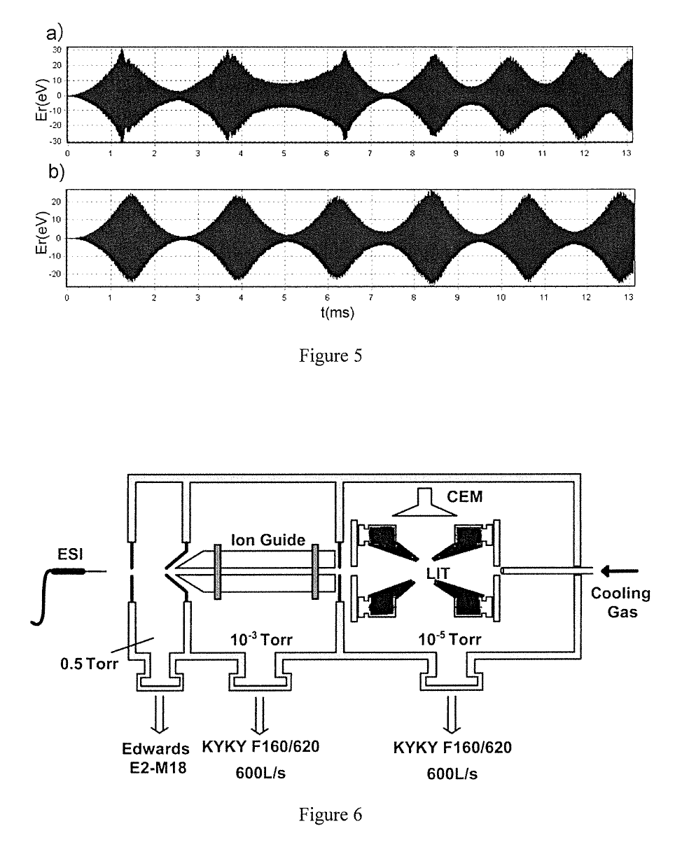

FIGS. 3, 4 and 5 show the simulation results of ion trajectory and ion kinetic energy according to the first embodiment of the present invention. The specific simulation conditions are q=0.25 for the ion-to-charge ratio of 556, the excitation signal amplitude is 100 mV, the collision gas is nitrogen, the gas pressure is 008 mTorr, and the temperature is 300 Ka. FIG. 3 illustrates that ions can be resonantly excited in x- and y-directions simultaneously by applying two dipolar AC signals to the two pairs of LIT electrodes. The excitation signal frequency is adjusted to the optimal value, that is, the ion kinetic energy is the largest, the other conditions are exactly the same, and the displacement of the ions in the X and Y directions is shifted. It can be seen that the solution of the invention allows ions to be simultaneously excited in both directions. FIG. 4 further shows a simulation of the trajectory of ions in the xy plane. For excitation in both directions, ions move approximately along the line x=y, and, for conventional excitation in one direction, along the line y=0. FIG. 5 shows the relationship between the unidirectional particle kinetic energy of a particle with time, the maximum kinetic energy of the two-way excitation is 32 eV, and the unidirectional is 25 eV, the method increases the ion kinetic energy by nearly 30%.

FIGS. 6-8 show the results of verification of the experimental protocol in embodiment 1 FIG. 6 shows experimental set-up for the electrospray ion source-delta electrode ion trap mass spectrometer designed and used by the laboratory itself. It is a homemade three-stage differential pumping vacuum system. The vacuum chamber in the vacuum chamber can reach a vacuum of 10−5 Torr. The nitrogen gas is used as the cooling gas. The gas pressure is maintained at 8×10−5. The ions generated by the Torra electrospray ion source pass through the sampling plate. The sampling cone enters the second-stage vacuum chamber and enters the triangular electrode ion trap mass analyzer under the transmission of a 200 mm long quadrupole ion guiding rod. Reagent: Leucine encephalin (m/z 556, Gil Biochemical Shanghai Co., Ltd.), solvent:methanol:water=50:50, which contains 0.5% acetic acid. The brain endorphin sample is a standard sample for studying the ion dissociation of electrospray ionization mass spectrometry. The ratio of the fragment ions a4 and b4 can reflect the internal energy of the ion deposition. The larger the ratio, the larger the internal energy of the deposition.

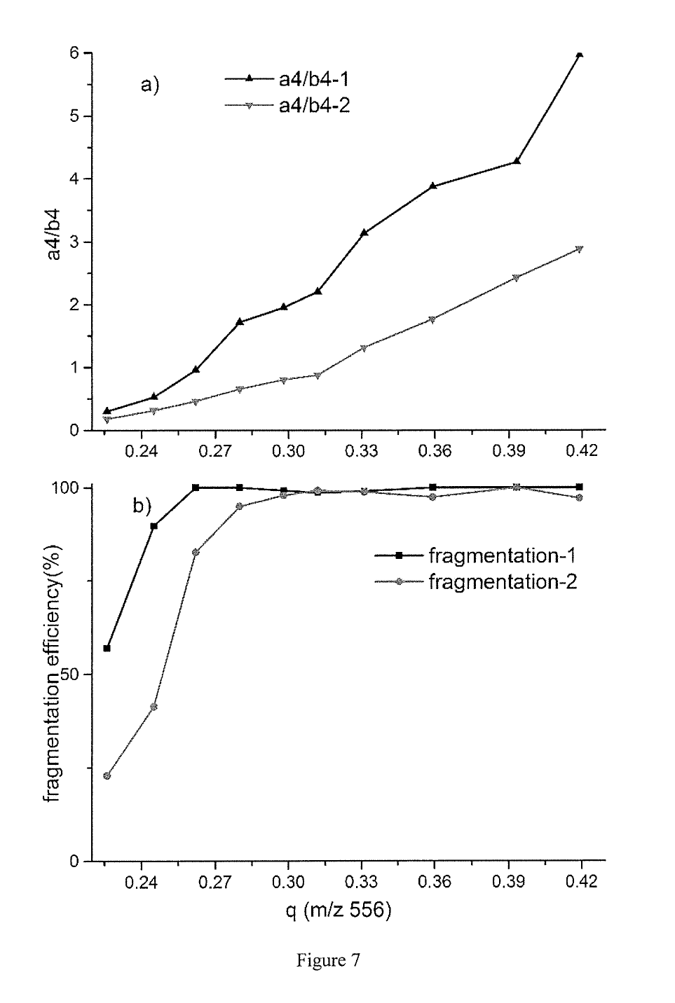

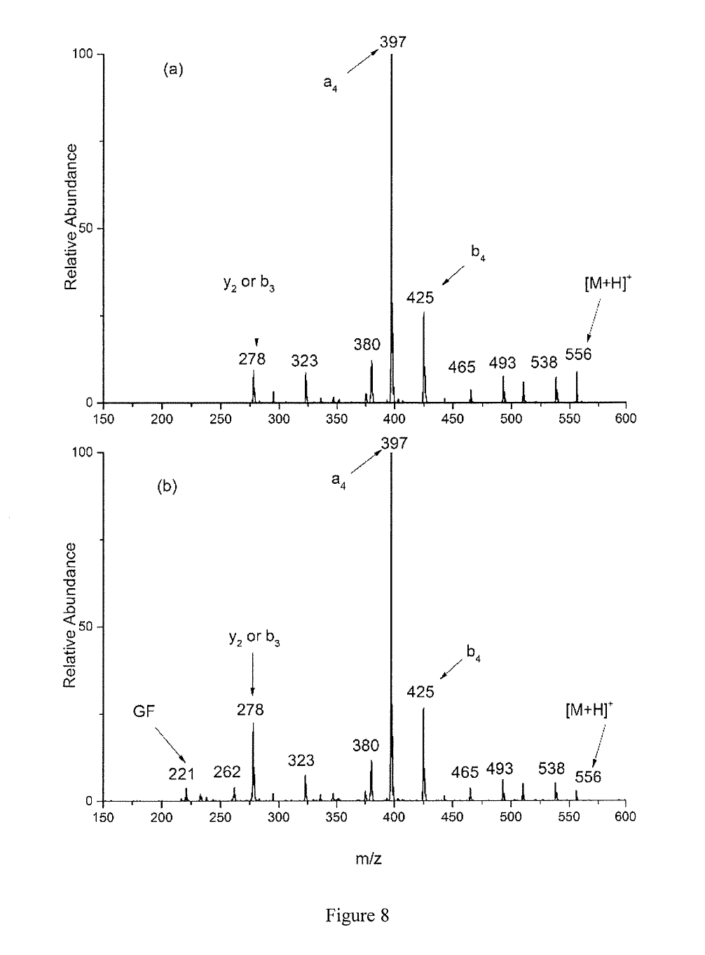

The experimental conditions in FIGS. 7 and 8 are as follows: the dissociation time is 20 ms, the excitation signal amplitude is 200 mV, and the excitation frequency is optimized to maximize the fragmentation efficiency or the ratio of a4 to b4. FIG. 7a reflects that the parent ion brain endorphin q is in the range of 0.23 to 0.42. The ion two-way excitation of the present invention is higher than the conventional one-way excitation of a4 and b4, that is, the internal energy of deposition is more, and the larger q is, the more obvious the effect. FIG. 7b is reflects a lower q value, and the two-way excitation fragmentation efficiency of the present invention is higher. FIG. 8 shows mass spectra of the CID results of protonated leucine enkephalin when a4/b4=3. FIG. 8a is the mass spectrum of the conventional one-way excitation, q is 0.33. FIG. 8b is

the mass spectrum of the two-way excitation of the present invention, q is 0.43. It can be seen that this method can observe more fragment ions.

1. A method of ion excitation for dissociation in linear ion traps, comprising: Applying two dipolar or monopole AC excitation signals to x and y pairs of electrodes in linear ion traps to cause ions to undergo excitation simultaneously in the radial x and y directions

2. The method of claim 1, wherein the excitation AC signal only contain a single frequency.

3. The method of claim 1, wherein the excitation AC signal is the sum of multiple frequency components.

4. The method of claim 1, wherein the waveforms applying to the x electrodes and y electrodes can be the same type. In this case, the frequency, amplitude, phase difference of the two AC signals can be the same or different. the phase difference varies from 0 to 360 degrees, but does not include 90 degrees.

5. The method of claim 1, wherein the types of the two AC waveforms applying to the two pairs of electrodes are completely different.

6. The method of claim 1, wherein the mass spectrometer can be quadrupoles, linear ion trap with the hyperbolic electrodes, rectilinear ion trap, or a triangular-electrode linear ion trap.

7. The method of claim 2, wherein the waveforms applying to the x electrodes and y electrodes can be the same type. In this case, the frequency, amplitude, phase difference of the two AC signals can be the same or different. the phase difference varies from 0 to 360 degrees, but does not include 90 degrees.

8. The method of claim 3, wherein the waveforms applying to the x electrodes and y electrodes can be the same type. In this case, the frequency, amplitude, phase difference of the two AC signals can be the same or different. the phase difference varies from 0 to 360 degrees, but does not include 90 degrees.

9. The method of claim 2, wherein the types of the two AC waveforms applying to the two pairs of electrodes are completely different.

10. The method of claim 3, wherein the types of the two AC waveforms applying to the two pairs of electrodes are completely different.

11. The method of claim 2, wherein the mass spectrometer can be quadrupoles, linear ion trap with the hyperbolic electrodes, rectilinear ion trap, or a triangular-electrode linear ion trap.
